(19) United States
(12) Patent Application Publication
(10) Pub. No.: US 2012/0312105 A1
(43) Pub. Date: Dec. 13, 2012

(54) MECHANISM FOR TRANSFORMING CIRCULAR MOTION INTO TRANSLATIONAL MOTION TO DRIVE THE PISTON OF A CNG COMPRESSOR

(76) Inventor: OSVALDO DEL CAMPO, Buenos Aires (AR)

(21) Appl. No.: 13/158,410

(22) Filed: Jun. 11, 2011

(51) Int. Cl. F16H 21/18

(52) U.S. Cl. 74/25

(57) ABSTRACT

The proposed mechanism is applied to a reciprocating piston compressor including at least two twin cylinders in each of which a set of piston-rod are housed. Both pistons being driven by the same driving means which in turn is driven by a crankshaft coupled to a motor. The assembly is also mounted on a chassis and covered with a casing. This mechanism comprises a parallelepiped housing defined by two side covers each of which is attached to the end of said rod. Such covers are linked to a driving piece that is in turn linked to the crankshaft counterweights. That way when the crankshaft rotates causes the up-down movement and at the same time a linear horizontal one.

### FIELD OF INVENTION

The present invention relates to a mechanism for transforming circular motion from, for example, the shaft of an electric motor or an internal combustion engine or the like to a translation movement for driving the pistons of a gas compressor, preferably a compressed natural gas (CNG) compressor.

Particularly it is related to a drive mechanism of a lubricated-type reciprocating gas compressor that receives a circular driving motion through an engine's shaft and becomes a linear drive motion to move the pistons of a compressor without using prior art rod-type systems, as will be explained in detail later.

### BACKGROUND OF THE INVENTION

Reciprocating compressors are already widely used in different industries, and are one of the oldest compressor designs, but remains being the most versatile and highly effective ones. This type of compressor drives a piston forward in a cylinder via a connecting rod and a crankshaft. If only one side of the piston is used for compression, it is described as a single action compressor. If both sides of the piston are used, top and bottom, it is called double action compressor.

The versatility of reciprocating compressors has no limits. It compresses both air and gases, with small modifications. The piston compressor is the only design capable of compressing air and gas to high pressures, such as breathing air applications.

The configuration of a piston compressor can be from a single cylinder for low pressure/low volume applications to a multi-stage configuration capable of compressing fluids to very high pressures. In the later case, air is compressed in stages, increasing the pressure before entering the next stage to compress also high pressure air.

Typical applications for this type of compression includes natural gas (CNG, nitrogen, inert gas, landfill gas), high pressure (breathing air for diving cylinders, seismic surveys, air injection circuits), PET bottling, boot motors, etc.

The mechanism for converting the circular motion of the driving motor shaft to a linear motion of the piston compressor commonly used in such compressors is the connecting rod-crank type. The most common current example of this type is found in the internal combustion engine of a car, where the linear movement of the piston is transmitted to the rod by the explosion of gasoline and becomes circular motion in the crankshaft.

But this mechanism is older than the automobile and was used in steam locomotives, although in this case it was for the inverse function, that is to say converting the linear motion of piston driven by high-pressure steam to a circular movement which drives the wheels of the locomotive. In schematic form, this mechanism is created with two “bars” joined together by a union of revolute. One end of the bar that rotates (the handle) is attached to a fixed point, the fulcrum, and the other end is attached to the rod. The remaining end of the rod is attached to a piston that moves in a straight line.

The reciprocating compressors operate on the adiabatic principle by which gas is introduced into the cylinder by the inlet valves; it is retained and compressed in the cylinder and exits through the exhaust valves, against the discharge pressure. These compressors are rarely used as individual units, unless the process requires intermittent operation. The reciprocating compressors have contact parts such as piston rings to cylinder walls, springs and valve plates or disks that are attached to their seats and between the gasket and rods. All these parties are subject to wear by friction. That is why they can be lubricated or non-lubricated. If the process allows it, it is preferable to have a lubricated compressor, because the pieces will last longer.

The reciprocating compressors should have, preferably, low-speed direct link engines, especially if they have more than 300 HP and work at constant speed.

Alternative piston compressors are classified according to the compression phase in single phase or dual phase. Single phase or single direction compressors are those which piston performs a single stage of compression (compression action is executed by only one side of the piston). Dual phase, biphasic, double effect or reciprocal compressors are those which piston performs a dual compression (compression action is performed by both sides of the piston).

The reciprocating compressors range from a very small capacity to about 3,000 PCMS and are used for high pressure and at a rather low cost. The number of stages or cylinders must be chosen in relation to the discharge temperatures, space available for the cylinders and load on the compressor body or rod.

Rather small size compressors, of up to about 100 HP, usually use a simple action cylinder, air cooling, and can allow the oil vapors in the tank (sump) to be mixed with air or compressed gas. These ones are desirable only in special modified designs.

Larger compressors for air or gas have two or more cylinders. In most facilities, the cylinders are arranged horizontally and in series so that they perform two or more stages of compression. The number of stages of compression depends largely on how much the temperature rises on each stage, usually limited to about 120° C. But is also depends on the load the rod that can handle and, occasionally, on the total pressure increase in one stage related to the design of the compressor valves, which usually support less than 1,000 psi.

The total compression ratio is determined to have an initial idea about the number of compression stages necessary. If the ratio is very high, between 3.0 and 3.5 for a single stage, then the square root of the overall relationship will be equal to the ratio per stage for the two stages, the cube root for three stages, etc. The inter-stage pressure and the ratio of actual stages will be modified after taking into account the pressure drop in inter-coolers, inter-stage pipeline, separators and pulsation dampers, if used.

Piston compressors compress gases and vapors in a cylinder through a piston in a rectilinear movement and are used for driving pneumatic tools (6 to 7 kg/cm2), ammonia refrigeration plants (up to 12 kg/cm2), supply gas transmission (up to 40 kg/cm2), liquefaction of air (up to 200 kg/cm2), compressed air locomotives (up 225 kg/cm2) and hydrogenation and synthesis under pressure (more than 1000 kg/cm2).

From the above it is clear that the linear-displacement reciprocating compressors driven by electric motors or internal combustion engines are already widely known in the art, but the object of this invention is to improve the mechanisms used to transform said circular motion from the engines to a linear driving motion applied to a compressor piston. As previously explained in detail, known compressors use a linkage system that although it has proven to be efficient for decades, due to the physical characteristics of the pieces involved, it is very difficult to miniaturize.

At present, reciprocating compressors without rod systems to transform the movement of the engine are not known. It is precisely an object of this invention to avoid these traditional rod mechanisms and replace them with a system to reduce the size of the set with significant benefits to manufacturing and maintenance applications.

### SUMMARY OF THE INVENTION

The present invention relates to a driving mechanism of a lubricated reciprocating gas compressor that receives circular motion from a motor shaft and converts it into a linear driving motion to move the pistons of a compressor. The purposed invention does not use traditional rod systems, but a rectangular driving piece that sits, on a linearly movable way, inside a chamber and is coupled to a crankshaft. When the crankshaft rotates the rectangular piece tries to rotate too, but divides the rotational movement in an up-down movement within the aforementioned camera and a horizontal linear movement of the right-left type. As the aforementioned camera has in turn the ends of the piston rods of the compressor linked, they cause the linear displacement thereof, as will be explained in detail later.

The purposed invention replaces the traditional rod systems with a simple mechanism that simplifies the set and their maintenance, and allows miniaturization.

In the description that follows we will not focus on the overall operation of the compressor since it is not part of this invention, but we will rather focus on the mechanism that receives the rotating movement of any engine and transforms it into a linear movement that drives the pistons of the compressor. The rest of the operation of the compressor is of the traditional type, that is to say that the entire sequence of suction, compression and exhaust, and the operation of the pistons, valves, lubrication, etc. are very well known in the art and they are included in some of the attached drawings for the sole purpose of drawing the whole equipment and therefore we will not describe its operation and are not part of the proposed inventive concept.

These and other aspects, features, and advantages of the present invention will become more readily apparent from the attached drawings and the detailed description of the preferred embodiments, which follow.

### BRIEF DESCRIPTION OF THE DRAWINGS

FIG. 1 is a general perspective view of a compressor including the purposed conversion mechanism of the present invention. In this embodiment the compressor has three pairs of twin opposed cylinders of different sizes. It is also possible to see in this figure the shaft to which the driving motor is coupled while the remaining internal means lie hidden behind a cover or block.

FIG. 2 is another general perspective view similar to the previous one but this time the cover or block has been removed to visualize in detail the crankshaft and the motion transformation mechanism of the present invention.

FIG. 3 is another perspective view showing in greater detail the parts of the invention proposed. The cylinders were removed to see in detail the crankshaft and transformation means.

FIG. 4 is a cross section view through A-A indicated in FIG. 2. The two opposite sides of the compressor cylinders with their pistons and connecting rods and the proposed transformation mechanism can be clearly seen, finally:

FIG. 5 is another cross sectional view, this time through B-B indicated in FIG. 2. There it can be seen that the illustrated compressor has three sets of twin opposing cylinders and to each of which corresponds one of the motion transmission mechanisms of the present invention.

### DETAILED DESCRIPTION OF THE INVENTION

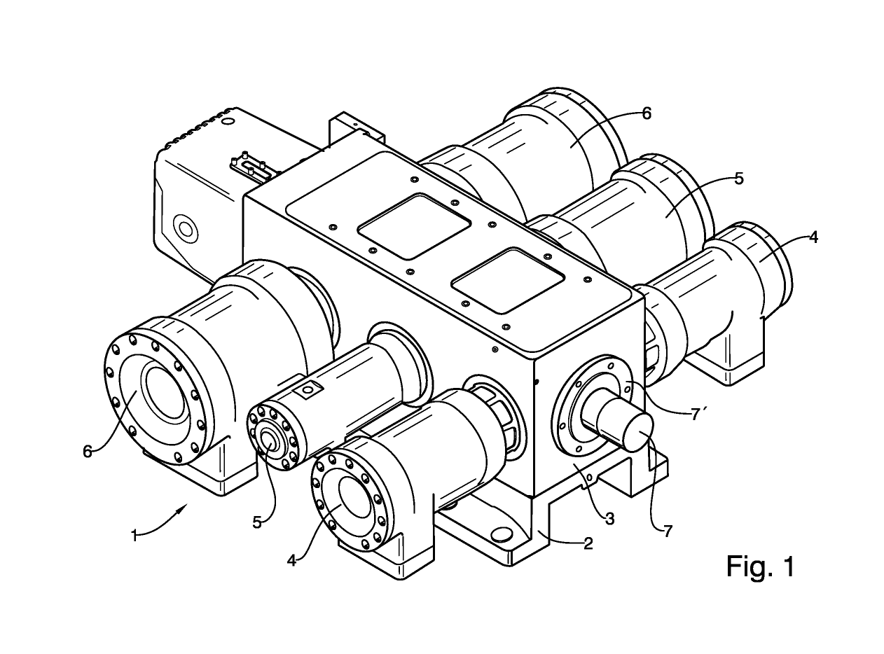

To the sole purpose of giving an overview of the compressor equipment in which the proposed mechanism is applied, but without entering into technical details thereof, we will start from FIG. 1 that illustrates the compressor equipment marked with the general reference 1, which has a chassis 2 on which a housing 3 containing the moving parts of the compressor is mounted. At the sides of the housing there are three pairs of opposing twin-cylinder 4-5-6 which have different sizes. Each pair of cylinders is aligned and houses a respective piston-rod system inside, as will be explained later.

At one end of the housing a shaft 7 extends and defines the nose of the crankshaft which is coupled, as usual, to an engine (not illustrated) that will be responsible for driving the compressor. At the end of said crankshaft, there is a wheel 7′.

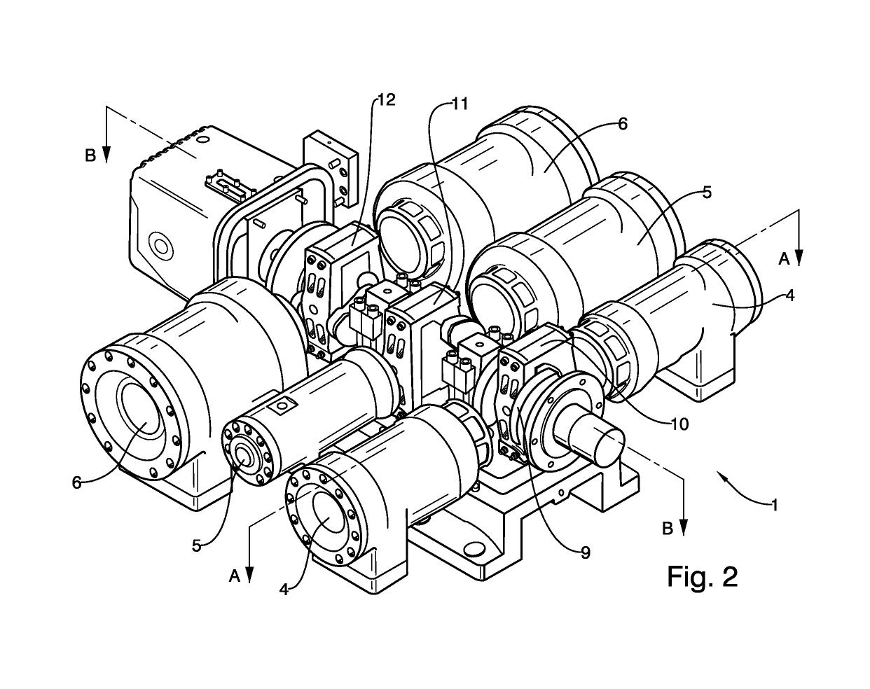

Referring now to FIG. 2, once the housing 3 is removed the crankshaft 9 can be seen in great detail. The proposed processing mechanism is coupled to said crankshaft and is marked with references 10-11 and 12, each of which corresponds to the pairs of cylinders 4-5-6 respectively. This means that each of these mechanisms is responsible for driving the pairs of pistons housed within the cylinders 4-5-6 according to the detail that follows.

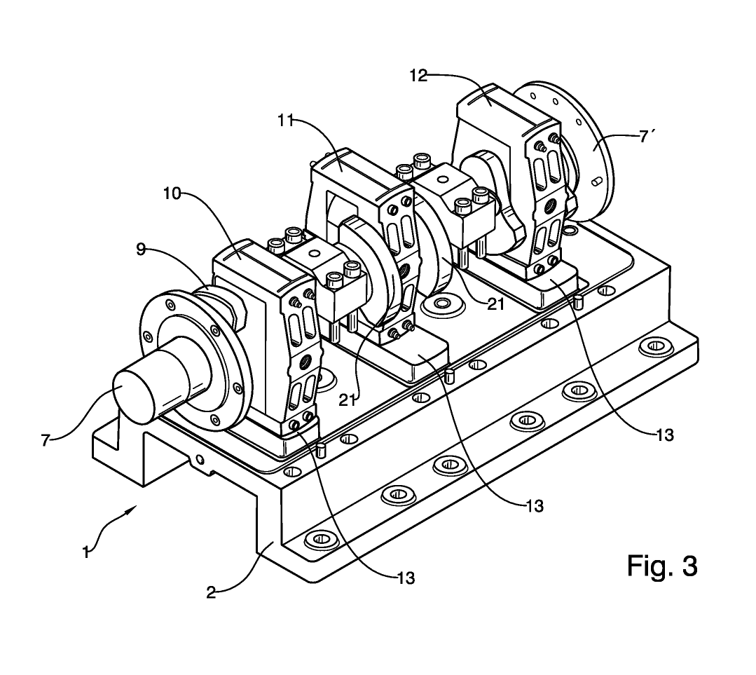

To complete this series of perspective figures which provide an overview of the whole compressor set where the proposed mechanism is applied, without limiting the application of this invention to this particular embodiment (it can be applied to any type of compressors) we now refer to FIG. 3. This Figure illustrates in detail the chassis 2 on which crankshaft 9 is mounted, and to which the purposed transmission mechanism 10-11-12 is coupled. For clarity purposes the set of cylinders and pistons have been removed in these figures to see, with greater detail, how the mechanism is mounted including openings 13 over which the purposed mechanism 10-11-12 moves.

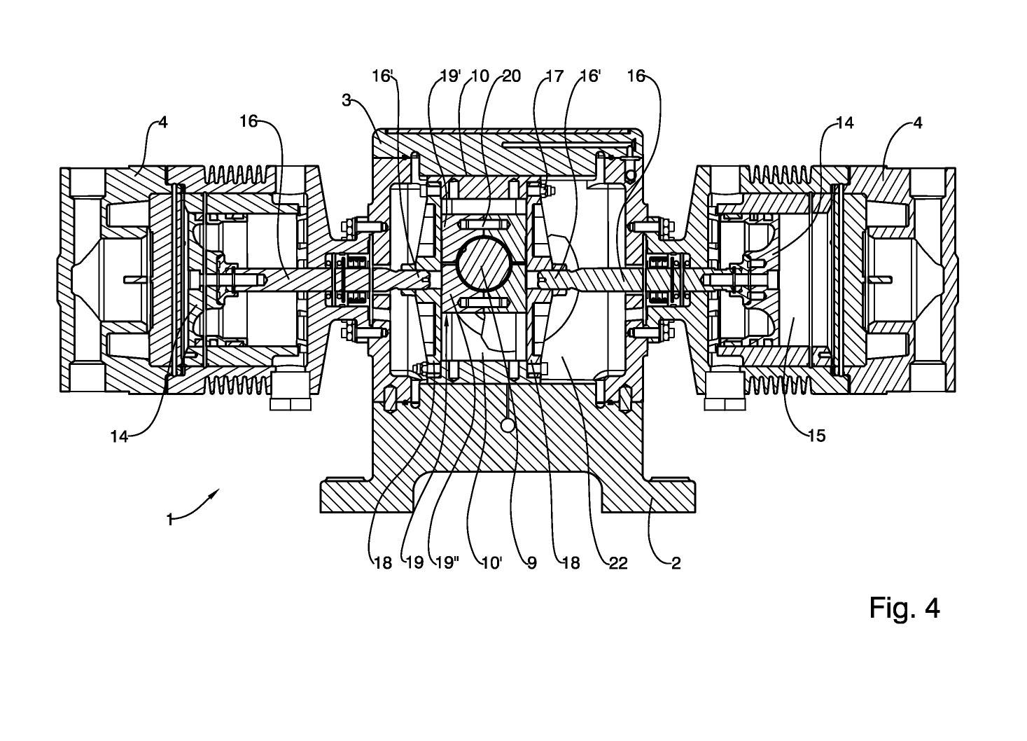

FIG. 4 is a cross sectional view which will be used later to detail the operation of the proposed mechanism. In the same we can visualize not only all the details of the mechanism 10 but the system of cylinder-piston-rod which is part of the compressor. We can broadly say that a piston 14 is housed in each cylinder 4 moving linearly within the compression chamber 15 of the mentioned cylinder 4. Attached to the piston is a connecting rod 16 which end 16′ instead of being coupled to the crankshaft through the connecting rod cap and screws is coupled via bolts 17 to a coupling plate 18 which in turn define the side covers of the parallelepiped housing 10 of the proposed mechanism. In this figure it can be clearly seen that the crankshaft 9 is linked to the central rectangular piece 19 of mechanism 10 and more particularly that the part 19 includes two halves 19′-19″ united by bolts ad-hoc 20.

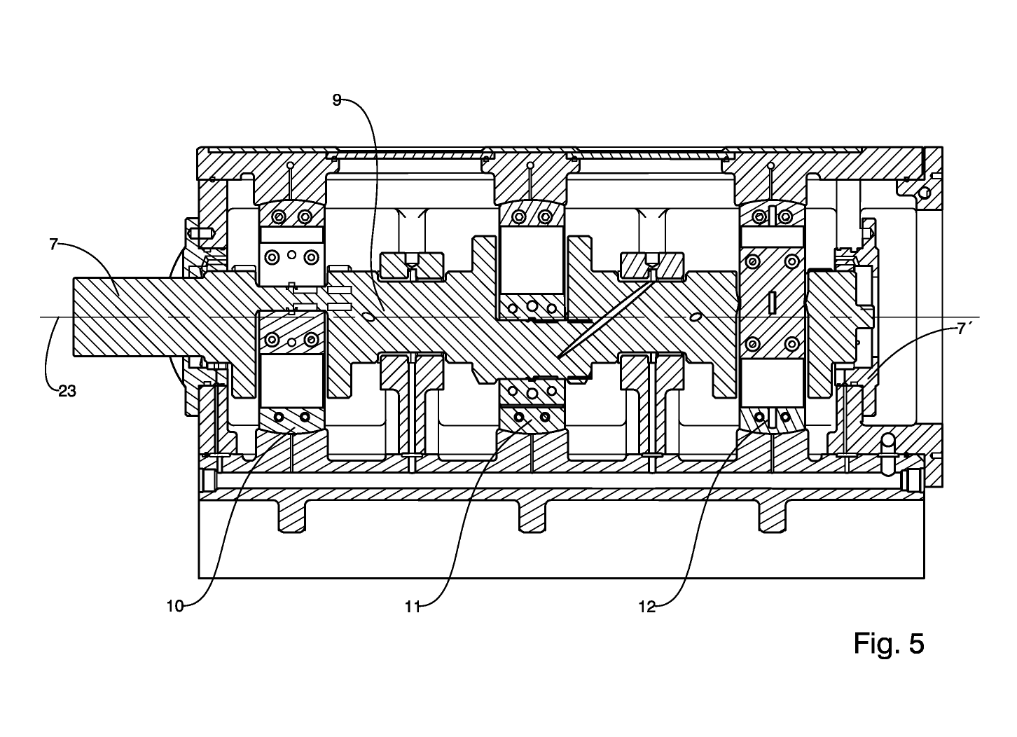

Finally we refer to FIG. 5 which is another longitudinal cross sectional view, this time through line B-B indicated in FIG. 2, and in which the whole development of the crankshaft from its tip or nose 7 to the wheel 7′, with their respective main gudgeons and counterweights, and mechanisms 10-11-12 can be clearly seen

### FUNCTIONAL DESCRIPTION OF THE INVENTION

We shall now make a detailed description of the compressor which includes the proposed mechanism, making quick and superficial references for the conventional parts of the compressor and detailed references for the proposed mechanism.

Compressor 1 has the tip of crankshaft 7 coupled to a motor (not shown) that can be an electric motor or internal combustion engine. This motor causes the rotation of crankshaft 9 and the subsequent turn of main gudgeons and counterweights 21. Being said rectangular piece 19 attached to the counterweight 21 of the crankshaft 9, when the crankshaft 9 rotates the driving rectangular piece 19 is also rotated. But said rectangular piece 19 cannot rotate as the counterweight because on one side it can move in an ascending-descending way inside the parallelepiped housing 10 and also the camera 10 moves linearly in a horizontal way 22 defined by the housing 3. Therefore when the crankshaft rotates and the counterweights 21 are moving in a circle around the longitudinal axis 23 the driving part 19 decomposes the circular motion in two linear motions, one up-down motion inside the parallelepiped housing 10 and another horizontal linear motion within the camera 22. As the end 16′ of the connecting rod 16 is linked to the lateral aspect of the aforementioned housing 10 through the plate 18, when it moves horizontally it also moves the rod horizontally, and consequently the piston 14.

Through a structurally and functionally simple construction as the receptacle 10 and the rectangular piece 19, the use of traditional rods can be avoided, which imply less wear and maintenance, but also the possibility of reducing the compressor size to achieve special applications, especially in the field of compressed natural gas compressors. Indeed, without limiting the scope of protection of the present invention, a preferred application of the proposed mechanism is on compressed natural gas (CNG) compressors.

While the preferred embodiments of the invention have been described above, it will be recognized and understood that various modifications can be made in the invention and the appended claims are intended to cover all such modifications which may fall within the spirit and scope of the invention

What is claimed is:

1. MECHANISM FOR TRANSFORMING CIRCULAR MOTION INTO TRANSLATIONAL MOTION TO DRIVE THE PISTON OF A CNG COMPRESSOR, of the type applicable in reciprocating piston compressors including at least two opposed twin cylinders in each of which a set of piston-rod is housed, both pistons being driven by the same driving means which in turn is driven by a crankshaft coupled to an engine; this assembly is also mounted on a chassis and covered by a housing, characterized the purposed mechanism for a parallelepiped housing defined by two lateral covers, each of which is attached to one end of the rod, those covers are linked to a driving piece that is in turn linked to the crankshaft counterweights.

2. MECHANISM FOR TRANSFORMING CIRCULAR MOTION INTO TRANSLATIONAL MOTION TO DRIVE THE PISTON OF A CNG COMPRESSOR in accordance to claim 1, characterized by the aforementioned driving piece has a rectangular shape.

3. MECHANISM FOR TRANSFORMING CIRCULAR MOTION INTO TRANSLATIONAL MOTION TO DRIVE THE PISTON OF A CNG COMPRESSOR in accordance to claim 1, characterized by the aforementioned driving piece is defined by two equal halves linked together by bolts.

4. MECHANISM FOR TRANSFORMING CIRCULAR MOTION INTO TRANSLATIONAL MOTION TO DRIVE THE PISTON OF A CNG COMPRESSOR in accordance to claim 1, characterized by the aforementioned driving piece is housed in a parallelepiped housing which in turn is housed in a chamber defined by the compressor housing.

5. MECHANISM FOR TRANSFORMING CIRCULAR MOTION INTO TRANSLATIONAL MOTION TO DRIVE THE PISTON OF A CNG COMPRESSOR in accordance to claim 1, characterized by the intended side covers are connected together by bolts defining the aforementioned parallelepiped accommodation.
